(19) United States
(12) Patent Application Publication
(10) Pub. No.: US 2017/0052106 A1
(43) Pub. Date: Feb. 23, 2017

(54) METHOD FOR LABEL-FREE IMAGE CYTOMETRY

(71) Applicants: THE BROAD INSTITUTE, INC., Cambridge, MA (US); SWANSEA UNIVERSITY, Swansea (GB); HELMHOLTZ ZENTRUM MUNCHEN, Oberschleissheim (DE)

(72) Inventors: Holger HENNIG, Haeberlinstr. (DE); Paul REES, Swansea (GB); Thomas BLASI, Munich (DE); Anne CARPENTER VAN DYK, Ashland, MA (US)

(73) Assignees: The Broad Institute, Inc., Cambridge, MA (US); Swansea University, Swansea (GB); Helmholtz Zentrum Munchen, Oberschleissheim (DE)

(21) Appl. No.: 15/307,706

(22) PCT Filed: Apr. 27, 2015
(86) PCT No.: PCT/US2015/027809

§ 371 Date: Oct. 28, 2016

Related U.S. Application Data
(60) Provisional application No. 61/985,236, filed on Apr. 28, 2014.
(60) Provisional application No. 62/088,151, filed on Dec. 5, 2014.
(60) Provisional application No. 62/135,820, filed on Mar. 20, 2015.

(51) Int. Cl. G01N 15/14

(52) U.S. Cl. CPC G01N 15/1475; G01N 2015/1488; G01N 2015/1006

(57) ABSTRACT

A computer-implemented method for the label-free classification of cells using image cytometry is provided. In some exemplary embodiments of the computer implemented method, the classification is the classification of the cells, such as individual cells, into a phase of the cell cycle or by cell type. A user computing device receives as an input one or more images of a cell obtained from a image cytometer. The user computing device extracts features form the one or more images, such as brightfield and/or darkfield images. The user computing device classifies the cell in the one or more images based on the extracted features using a cell classifier. The user computing device then outputs the class label of the cell, as defined by the classifier.

### CROSS REFERENCE TO RELATED APPLICATION

This application claims the priority benefit of the earlier filing date of U.S. Provisional Application No. 61/985,236, filed Apr. 28, 2014, U.S. Provisional Application No. 62/088,151, filed Dec. 5, 2014, and U.S. Provisional Application No. 62/135,820, filed Mar. 20, 2015, all of which are herein incorporated by reference in their entirety.

### FIELD OF THE DISCLOSURE

The present disclosure relates generally to methods and systems for unlabeled sorting and/or characterization using imaging flow cytometry.

### BACKGROUND

Flow cytometry is used to characterize cells and particles by making measurements on each cell at rates up to thousands of events per second. In typical flow cytometry, the measurements consist of the simultaneous detection of the light scatter and fluorescence associated with each event, for example fluorescence associated with markers present on the surface or internal to a cell. Commonly, the fluorescence characterizes the expression of cell surface molecules or intracellular markers sensitive to cellular responses to drug molecules. The technique often permits homogeneous analysis such that cell associated fluorescence can often be measured in a background of free fluorescent indicator. The technique often permits individual particles to be sorted from one another. Flow cytometry has emerged as a powerful method to accurately quantify proportions of cell populations by labeling the investigated cells with distinguishing fluorescent stains.

More recently, imaging flow cytometry has emerged as an alternative to traditional fluorescence flow cytometry. Compared to conventional flow cytometry, imaging flow cytometry can capture not only an integrated value per fluorescence channel, but also a full image of the cell providing additional spatial information. Thus, imaging flow cytometry can combine the statistical power and sensitivity of standard flow cytometry with the spatial resolution and quantitative morphology of digital microscopy.

### SUMMARY OF THE DISCLOSURE

In certain example aspects described herein, a computer-implemented method for the label-free classification of cells using image cytometry is provided. In some exemplary embodiments of the computer-implemented method, the classification is the classification of the cells, such as individual cells, into a phase of the cell cycle or of a cell type. A user computing device receives as an input one or more images of a cell obtained from a image cytometer. The user computing device extracts features from the one or more images, such as brightfield and/or darkfield (side scatter) images. The user computing device classifies the cell in the one or more images based on the extracted features using a cell classifier. The user computing device then outputs the class label of the cell, as defined by the classifier.

In certain other example aspects, a system for the label-free classification of cells using image cytometry is also provided. Also provided in certain aspects is a computer program product for the label-free classification of cells using image cytometry.

The foregoing and other features of this disclosure will become more apparent from the following detailed description of a several embodiments, which proceeds with reference to the accompanying figures.

### BRIEF DESCRIPTION OF THE FIGURES

FIG. 1 is a block diagram depicting a system, such as an imaging flow cytometer, for processing the label free classification of cells, in accordance with certain example embodiments.

FIG. 2 is a block flow diagram depicting a method for the label free classification of cells, in accordance with certain example embodiments.

FIG. 3 is a block flow diagram depicting a method for feature extraction from cell images, in accordance with certain example embodiments.

FIG. 4 is a block flow diagram depicting a method for cell classification from cell images, in accordance with certain example embodiments.

FIG. 5 is a block diagram depicting a computing machine and a module, in accordance with certain example embodiments.

FIG. 6A-6H is a set of panels depicting how supervised machine learning allows for robust label-free prediction of DNA content and cell cycle phases based only on brightfleld and darkfield images. 6A, First the brightfleld and darkfield images of the cells are acquired by an imaging flow cytometer. To allow visual inspection the individual brightfleld and darkfield images are tiled into 15×15 montages. Then, the montages are loaded into the open-source imaging software CellProfiler for segmentation and feature extraction and extract a total of 213 morphological features (See Table 3). These features are the input for supervised machine learning, namely classification and regression. 6B, Based only on brightfleld and darkfield features, a Pearson-correlation of r=0.903±0.004 was found between actual DNA content and predicted DNA content using regression (See Methods). Dashed lines indicate typical gating thresholds for the G1, S and G2/M phases (from low intensity to high). 6C-6G, For cells that are actually in a particular phase (e.g., c shows cells in G1/S/G2), the bar plots show the classification results (See Methods) (e.g., c shows that the few cells in P, M, A, and T are errors). 6H, A bar plot of the true positive rates of the cell cycle classification. Using boosting with random undersampling to compensate for class imbalances, true positive rates of 54.7±8.8% (P), 51.0±25.0% (M), 100% (A and T) and 92.6±0.7% (G1/S/G2) are obtained.

FIG. 7 is a set of digital images of the cells captured by imaging flow cytometry. Typical brightfield, darkfield, PI and pH3 images of cells in the G1/S/G2 phases, prophase, metaphase, anaphase and telophase of the cell cycle.

FIG. 8 shows the ground truth determination of prophase, metaphase and anaphase. Morphological metrics on the pH3 positive cells' PI images were used to identify prophase, metaphase and anaphase.

FIG. 9 is a bar graph showing cell cycle phase classification of yeast cells. 20,446 yeast cells were measured on an ImageStream® imaging flow cytometer. The cells were initially separated into 3 classes using fluorescent stains: ‘G1/M’ (2,440 cells), ‘G2’ (17111 cells) and ‘S’ (895 cells). Machine learning based on the features extracted from both brightfield images and darkfield images (neglecting the stains) could classify the cell cycle stage of the cells correctly with a percentage of 89.1% in total. An analysis is also shown of how classification performs if only the extracted features of only the brightfield images or only the darkfield images are used.

FIG. 10 is a bar graph showing a cell cycle phase classification of Jurkat cells. 15,712 Jurkat cells were measured on an ImageStream® imaging flow cytometer. The cells were initially separated into 4 classes using fluorescent stains: ‘G1,S,G2,T’ (15,024 cells), ‘Prophase’ (15 cells), ‘Metaphase’ (68 cells) and ‘Anaphase’ (605 cells). Using machine learning based on the features extracted from the brightfield images only (neglecting the stains) the cells could be classified in particular phases of the cell cycle stage correctly with 89.3% accuracy.

### DETAILED DESCRIPTION OF SEVERAL EMBODIMENTS

Unless otherwise noted, technical terms are used according to conventional usage. Definitions of common terms in molecular biology may be found in Benjamin Lewin, Genes IX, published by Jones and Bartlet, 2008 (ISBN 0763752223); Kendrew et al. (eds.), The Encyclopedia of Molecular Biology, published by Blackwell Science Ltd., 1994 (ISBN 0632021829); and Robert A. Meyers (ed.), Molecular Biology and Biotechnology: a Comprehensive Desk Reference, published by VCH Publishers, Inc., 1995 (ISBN 9780471185710).

The singular terms “a,” “an,” and “the” include plural referents unless context clearly indicates otherwise. Similarly, the word “or” is intended to include “and” unless the context clearly indicates otherwise. The term “comprises” means “includes.” In case of conflict, the present specification, including explanations of terms, will control.

To facilitate review of the various embodiments of this disclosure, the following explanations of specific terms are provided:

Brightfield image: An image collected from a sample, such as a cell, where contrast in the sample is caused by absorbance of some of the transmitted light in dense areas of the sample. The typical appearance of a brightfield image is a dark sample on a bright background.

Conditions sufficient to detect: Any environment that permits the desired activity, for example, that permits the detection of an image, such as a darkfield and/or brightfield image of a cell.

Control: A reference standard. A control can be a known value or range of values, for example a set of features of a test set, such as a set of cells indicative of one or more stages of the cell cycle. In some embodiments, a set of controls, such as cells, is used to train a classifier.

Darkfield image: An image, such as an image of a cell collected from light scattered from a sample and captured in the objective lens. In some examples, the darkfield image is collected at a 90° angle to the incident light beam. The typical appearance of a darkfield image is a light sample on a dark background.

Detect: To determine if an agent (such as a signal or particular cell or cell type, such as a particular cell in a phase of the cell cycle or a particular cell type) is present or absent. In some examples, this can further include quantification in a sample, or a fraction of a sample.

Detectable label: A compound or composition that is conjugated directly or indirectly to another molecule to facilitate detection of that molecule or the cell it is attached to. Specific, non-limiting examples of labels include fluorescent tags.

Electromagnetic radiation: A series of electromagnetic waves that are propagated by simultaneous periodic variations of electric and magnetic field intensity, and that includes radio waves, infrared, visible light, ultraviolet light, X-rays and gamma rays. In particular examples, electromagnetic radiation is emitted by a laser or a diode, which can possess properties of monochromaticity, directionality, coherence, polarization, and intensity. Lasers and diodes are capable of emitting light at a particular wavelength (or across a relatively narrow range of wavelengths), for example such that energy from the laser can excite a fluorophore.

Emission or emission signal: The light of a particular wavelength generated from a fluorophore after the fluorophore absorbs light at its excitation wavelengths.

Excitation or excitation signal: The light of a particular wavelength necessary to excite a fluorophore to a state such that the fluorophore will emit a different (such as a longer) wavelength of light.

Fluorophore: A chemical compound or protein, which when excited by exposure to a particular stimulus such as a defined wavelength of light, emits light (fluoresces), for example at a different wavelength (such as a longer wavelength of light). Fluorophores are part of the larger class of luminescent compounds. Luminescent compounds include chemiluminescent molecules, which do not require a particular wavelength of light to luminesce, but rather use a chemical source of energy. Examples of particular fluorophores that can be used in methods disclosed herein are provided in U.S. Pat. No. 5,866,366 to Nazarenko et al., such as 4-acetamido-4′-isothiocyanatostilbene-2,2′disulfonic acid, acridine and derivatives such as acridine and acridine isothiocyanate, 5-(2′-aminoethyl)aminonaphthalene-1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide, anthranilamide, Brilliant Yellow, coumarin and derivatives such as coumarin, 7-amino-4-methylcoumarin (AMC, Coumarin 120), 7-amino-4-trifluoromethylcoumuarin (Coumaran 151); cyanosine; 4′,6-diaminidino-2-phenylindole (DAPI); 5′,5″-dibromopyrogallol-sulfonephthalein (Bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansyl chloride); 4-dimethylaminophenylazophenyl-4′-isothiocyanate (DABITC); eosin and derivatives such as eosin and eosin isothiocyanate; erythrosin and derivatives such as erythrosin B and erythrosin isothiocyanate; ethidium; fluorescein and derivatives such as 5-carboxyfluorescein (FAM), 5-(4,6-dichlorotriazin-2-yl)aminofluorescein (DTAF), 2′7′-dimethoxy-4′5′-dichloro-6-carboxyfluorescein (JOE), fluorescein, fluorescein isothiocyanate (FITC), and QFITC (XRITC); fluorescamine; IR144; IR1446; Malachite Green isothiocyanate; 4-methylumbelliferone; ortho cresolphthalein; nitrotyrosine; pararosaniline; Phenol Red; B-phycoerythrin; o-phthaldialdehyde; pyrene and derivatives such as pyrene, pyrene butyrate and succinimidyl 1-pyrene butyrate; Reactive Red 4 (Cibacron® Brilliant Red 3B-A); rhodamine and derivatives such as 6-carboxy-X-rhodamine (ROX), 6-carboxyrhodamine (R6G), lissamine rhodamine B sulfonyl chloride, rhodamine (Rhod), rhodamine B, rhodamine 123, rhodamine X isothiocyanate, sulforhodamine B, sulforhodamine 101 and sulfonyl chloride derivative of sulforhodamine 101 (Texas Red); N,N,N′,N′-tetramethyl-6-carboxyrhodamine (TAMRA); tetramethyl rhodamine; tetramethyl rhodamine isothiocyanate (TRITC); riboflavin; rosolic acid and terbium chelate derivatives; LightCycler Red 640; Cy5.5; and Cy56-carboxyfluorescein; 5-carboxyfluorescein (5-FAM); boron dipyrromethene difluoride (BODIPY); N,N,N′,N′-tetramethyl-6-carboxyrhodamine (TAMRA); acridine, stilbene, -6-carboxy-fluorescein (HEX), TET (Tetramethyl fluorescein), 6-carboxy-X-rhodamine (ROX), Texas Red, 2′,7′-dimethoxy-4′,5′-dichloro-6-carboxyfluorescein (JOE), Cy3, Cy5, VIC® (Applied Biosystems), LC Red 640, LC Red 705, Yakima yellow amongst others. Other suitable fluorophores include those known to those skilled in the art, for example those available from Life Technologies™ Molecular Probes® (Eugene, Oreg.) or GFP and related fluorescent proteins.

Sample: A sample, such as a biological sample, that includes biological materials (such as cells of interest).

### Overview

A well-known method for cell sorting is Fluorescence-Activated Cell Sorting (FACS). Often, a set of cells to be sorted can include (i) a heterogeneous mixture of cells, (ii) cells that are not synchronized, i.e., cells that are in different phases of the cell cycle, (iii) cells that are treated with different drugs. The fluorescent channels available on a traditional FACS machine are limited. Thus, it would be advantageous to be able to sort such diverse populations of cells, without having to use the limited number of fluorescent channels available on an imaging flow cytometer, for example using brightfield and/or darkfield images. This disclosure meets that need by providing a computer implemented method that makes use of the brightfield and/or darkfield images to sort, both digitally and physically, by virtue of features present in those images.

As disclosed herein, the method uses the images acquired from an imaging flow cytometer, such as the brightfield and/or darkfield images, to assign cells to certain cell classes, such as cells in various phases of the cell cycle or by cell type, without the need to stain the input cells. Using only non-fluorescence channels saves costs, reduces potentially harmful perturbations to the sample, and leaves other fluorescence channels available to analyze other aspects of the cells. The disclosed methods typically include imaging of the cells in imaging flow cytometry, segmenting the images of the cells, such as the bright field image but not the dark field image, and extracting a large number of features from the images, for example, using the software CellProfiler. Machine learning techniques are used to classify the cells based on the extracted features, as compared to a defined test set used to train the cell classifier. After assignment of a particular cell class, for example a phase of the cell cycle or by type of cell, the cells can be sorted into different bins using standard techniques based on the classification, for example physically sorted and/or digitally sorted, for example to create a graphical representation of the cell classes present in a sample.

As disclosed in the Examples and accompanying figures, the results using different cell types (mammalian cells and fission yeast) show that the features extracted from the brightfield images alone can be sufficient to classify the cells with respect to their cell cycle phase with high accuracy using state of the art machine learning techniques.

Several advantages exist for the disclosed methods over tradition FACS. Among others, there advantages include the following: the cells do not have to be labeled with additional stains, which are costly and may have confounding effects on the cells; and the flow cytometry machines do not necessarily have to be equipped with detectors for fluorescence signals. Furthermore, samples used in an imaging may be returned to culture, allowing for further analysis of the same cells over time, since cell state is not otherwise altered by use of one or more stains. In addition, cells that are out of focus can be identified in the brightfield and, if necessary, discarded.

Disclosed herein is a computer-implemented method for the label-free classification of cells using image cytometry, for example for the label free classification of the cells into phases of the cell cycle, among other applications. Brightfield and/or darkfield images of a cell or a set of cells are acquired and/or received. These images include features, which can be used to define or classify the cell shown in the image. The features, such one ore more of those shown in Table 1 and or Table 3, are extracted from the images, for example using software such as CellProfiler, available on the world wide web at www.cellprofiler.org.

Using the extracted features, a cell shown in the one or more images is classified using a classifier that has been trained on a control sample to recognize and classify the cells in the images based on the features and values derived therefrom. The classifier assigns a cell class to the cell present in the image, which can be output, for example output as a graphical output, or as instructions for a cell sorter to sort the cells of the individual classes into bins, such as digital bins (histograms) and/or physical bins, such as containers, for example for subsequent use or analysis.

In some embodiments, only the darkfield image is used to classify the cell. In some embodiments, only the brightfield image is used to classify the cell. In some embodiments, both the darkfield and brightfield images are used to classify the cell.

In some embodiments, the images are acquired, for example using an imaging flow cytometer that is integral or coupled to a user interface, such as a user computing device. For example a user can set the imaging flow cytometer to analyze a sample of cells, for example to classify the cells in the sample as in certain phases of the cell cycle. In some embodiments, the cells are sorted based on the class label of the cells.

In one aspect, the method comprises classifying cells based directly on the images, i.e., without extracting features. For example, an image may be reformatted as a vector of pixels and machine learning can be applied directly to these vectors. In one aspect, machine learning methods that are able to perform a classification based directly on the images. In one aspect, this machine learning may be termed “deep learning”. In one aspect, the method comprises a computer-implemented method for the label-free classification of cells using image cytometry, comprising: receiving, by one or more computing devices, one or more images of a cell obtained from a image cytometer; classifying, by the one or more computing devices, the cell based on the images using machine learning methods; outputting by the one or more computing devices, the class label of the cell.

In one example the ImageStream® system is a commercially available imaging flow cytometer that combines a precise method of electronically tracking moving cells with a high resolution multispectral imaging system to acquire multiple images of each cell in different imaging modes. The current commercial embodiment simultaneously acquires six images of each cell, with fluorescence sensitivity comparable to conventional flow cytometry and the image quality of 40×-60× microscopy. The six images of each cell comprise: a side-scatter (darkfield) image, a transmitted light (brightfield) image, and four fluorescence images corresponding roughly to the FL1, FL2, FL3, and FL4 spectral bands of a conventional flow cytometer. The imaging objective has a numeric aperture of 0.75 and image quality is comparable to 40× to 60× microscopy, as judged by eye. With a throughput up to 300 cells per second, this system can produce 60,000 images of 10,000 cells in about 30 seconds and 600,000 images of 100,000 cells in just over 5 minutes.

In some embodiments between about 2 and about 500 features are extracted from the images, such as 5 or more, 10 or more, 15 or more, 20 or more, 25 or more, 30 or more, 35 or more, 40 or more, 45 or more, 50 or more, 55 or more, 60 or more, 65 or more, 70 or more, 75 or more, 80 or more, 85 or more, 90 or more 95 or more, 100 or more, 200 or more, 300 or more, or 400 or more. In some embodiments, the features extracted from the images include 2 or more of the features listed in Table 1 and or Table 3, such as 5 or more, 10 or more, 15 or more, 20 or more, 25 or more, 30 or more, 35 or more, 40 or more, 45 or more, 50 or more, 55 or more, 60 or more, 65 or more, 70 or more, 75 or more, 80 or more, 85 or more, 90 or more 95 or more, or 100 or more. In some embodiments, features extracted from the images define one or more of the texture, the area and shape, the intensity, the Zernike polynomials, the radial distribution, and the granularity are extracted from the images.

In some embodiments between about 2 and about 500 features are used to classify the cells, such as 5 or more, 10 or more, 15 or more, 20 or more, 25 or more, 30 or more, 35 or more, 40 or more, 45 or more, 50 or more, 55 or more, 60 or more, 65 or more, 70 or more, 75 or more, 80 or more, 85 or more, 90 or more 95 or more, 100 or more, 200 or more, 300 or more, or 400 or more. In some embodiments, the features used to classify the cells include 2 or more of the features listed in Table 1 and or Table 3, such as 5 or more, 10 or more, 15 or more, 20 or more, 25 or more, 30 or more, 35 or more, 40 or more, 45 or more, 50 or more, 55 or more, 60 or more, 65 or more, 70 or more, 75 or more, 80 or more, 85 or more, 90 or more 95 or more, or 100 or more. In some embodiments, the features used to classify the cells include one or more of the texture, the area and shape, the intensity, the Zernike polynomials, the radial distribution, and the granularity. In some embodiments, the weighting of the features of the cells that contribute to the classification of the cells proceeds as follows: the texture; the area and shape; the intensity; the Zernike polynomials; the radial distribution; and the granularity.

In some embodiments, to aid in analysis, the brightfield images are segmented to find the cell in the image and segmented brightfield images are then used for feature extraction.

The disclosed methods use a classifier to classify the images and thus the cells. In some embodiments, the classifier is derived by obtaining a set of cell images of a control set of cells with the correct class label and training the classifier to identify cell class with machine learning.

### Example System Architectures

Turning now to the drawings, in which like numerals indicate like (but not necessarily identical) elements throughout the figures, example embodiments are described in detail.

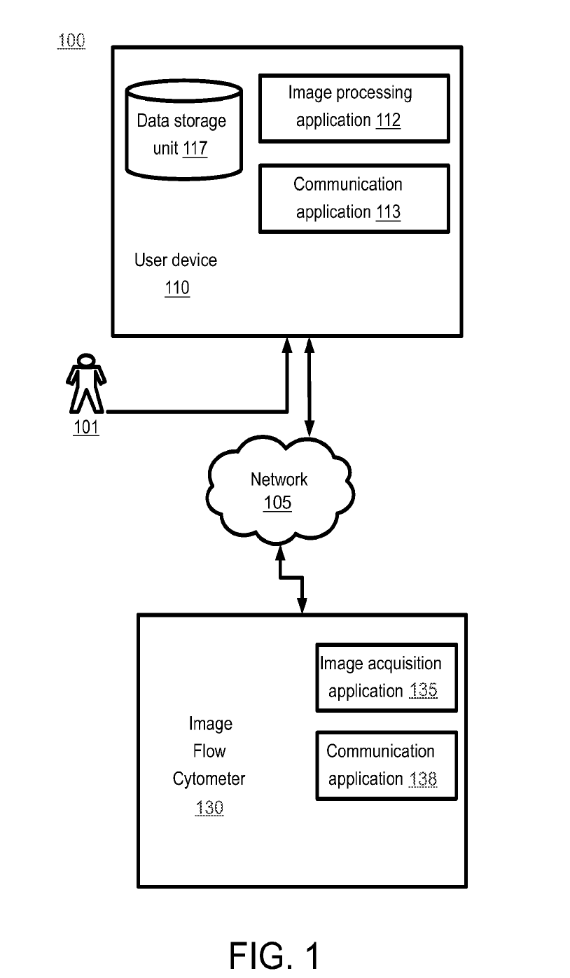

FIG. 1 is a block diagram depicting a system for processing the label free classification of cells, in accordance with certain example embodiments.

As depicted in FIG. 1, the exemplary operating environment 100 includes a user network computing device 110, and an imaging flow cytometer system 130.

Each network 105 includes a wired or wireless telecommunication means by which network devices (including devices 110 and 130) can exchange data. For example, each network 105 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment. In some embodiments, the user network computing device 110 and the imaging flow cytometer system 130 are contained in a single device or system.

Where applicable, each network computing device 110 and 130 includes a communication module capable of transmitting and receiving data over the network 105, for example cell image data, cell classification data, cell sorting data. For example, each network device 110 and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110 and 130 are operated by end-users. In some examples, the network devices 110 and 130 are integrated into a single device or system, such as an imaging flow cytometer, for example wherein the system includes a data storage unit that can include instructions for carrying out the computer implemented methods disclosed herein.

The user 101 can use the communication application 113, such as a web browser application or a stand-alone application, to view, download, upload, or otherwise access documents, graphical user interfaces, input systems, such as a mouse, keyboard, or voice command, output devices, such as video screens or printers, or web pages via a distributed network 105. The network 105 includes a wired or wireless telecommunication system or device by which network devices (including devices 110 and 130) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, near field communication (NFC), or any combination thereof or any other appropriate architecture or system that facilitates the communication of signals, data, and/or messages.

The communication application 113 of the user computing device 110 can interact with web servers or other computing devices connected to the network 105. For example, the communication application 113 can interact with the user network computing device 110 and the imaging flow cytometer system 130. The communication application 113 may also interact with a web browser, which provides a user interface, for example, for accessing other devices associated with the network 105.

The user computing device 110 includes image processing application 112. The image processing application 112, for example, communicates and interacts with the imaging flow cytometer system 130, such as via the communication application 113 and/or communication application 138.

The user computing device 110 may further include a data storage unit 117. The example data storage unit 117 can include one or more tangible computer-readable storage devices. The data storage unit 117 can be a component of the user device 110 or be logically coupled to the user device 110. For example, the data storage unit 117 can include on-board flash memory and/or one or more removable memory cards or removable flash memory.

The image cytometer system 130 represents a system that is capable of acquiring images, such as brightfield and/or darkfield images of cells, for example using image acquisition application 135, the images can be associated with a particular cell passing through the imaging flow cytometer. The image cytometer system 130 may also include an accessible data storage unit (not shown) or be logically coupled to the data storage unit 117 of user device 110, for example to access instructions and/or other stored files therein. In some examples, the image cytometer system 130 is capable of acquiring fluorescence data about the cell, such as can be acquired with any flow cytometry device, such as a fluorescent activated cell sorter (FACS), for example fluorescence data associated with cells passing through the imaging flow cytometer.

It will be appreciated that the network connections shown are examples and other means of establishing a communications link between the computers and devices can be used. Moreover, those having ordinary skill in the art and having the benefit of the present disclosure will appreciate that the user device 110 and image cytometer system 130 in FIG. 1 can have any of several other suitable computer system configurations.

### Example Processes

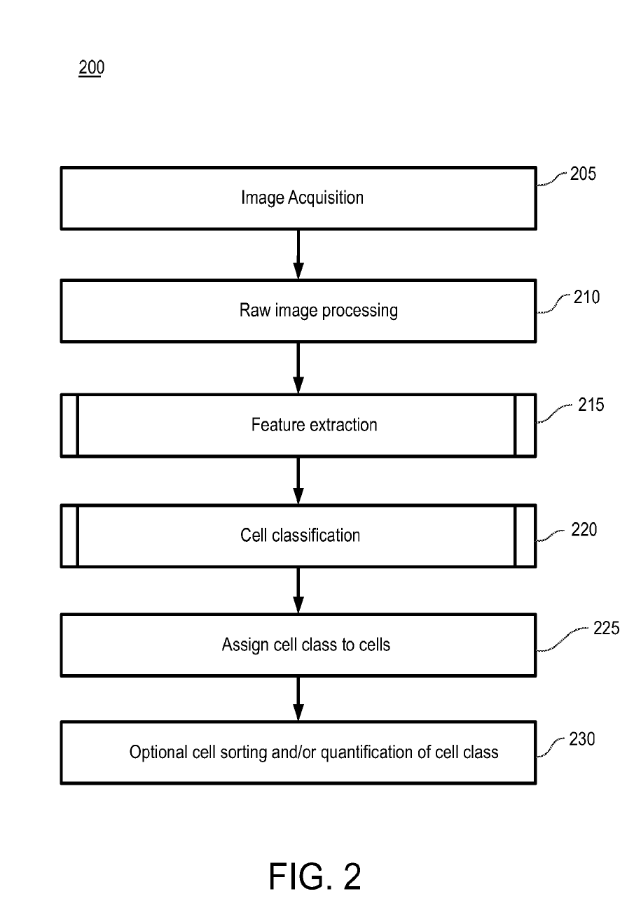

The components of the example operating environment 100 are described hereinafter with reference to the example methods illustrated in FIG. 2.

FIG. 2 is a block flow diagram depicting a method 200 for the label free classification of cells, in accordance with certain example embodiments.

With reference to FIGS. 1 and 2, in block 205, the image cytometer system 130 collects and optionally stores images of cells as they pass through the cytometer. The raw images captured by an imaging flow cytometer are used as the input signal for the remainder of the workflow. The collected images are passed to the user computing device 110 via network 105, for example with a communication application 113, which may be embedded in the cytometer, or a stand-alone computing device. The raw data can be stored in the user device, for example in data storage unit 117.

In block 210, the raw image can be optionally subject to preprocessing, for example to remove artifacts or skip images that do not contain usable images for subsequent analysis. In some example, the cells contained in such images are automatically discarded, for example transferred into a waste receptacle.

In block 215, features of the cells are extracted from the images obtained using the brightfield and/or darkfield techniques, for example using CellProfiler software. In some examples between about 2 and about 200 features are extracted from the images. In specific examples between 2 and 101 features shown In Table 1 and or 3 are extracted from each brightfield image and/or darkfield images.

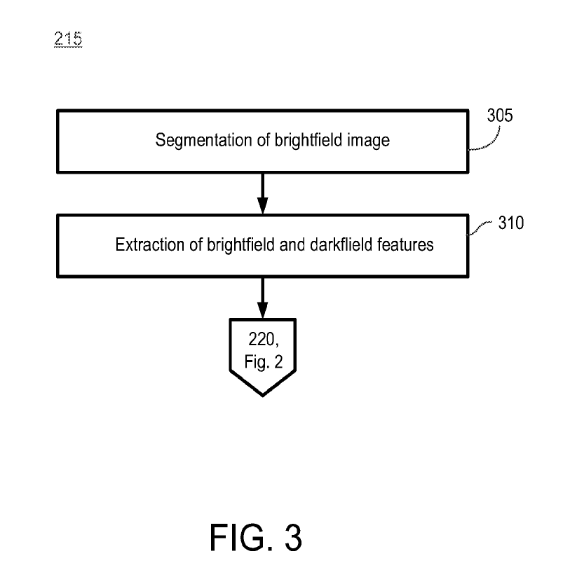

Example details of block 215 are described hereinafter with reference to FIG. 3.

FIG. 3 is a block flow diagram depicting a method 215 for feature extraction of cell images, as referenced in block 215 of FIG. 2.

With reference to FIGS. 1, 2 and 3, in block 305 of method 215, the brightfield image is segmented to find the location of the cell or subcellular structures in the brightfield image, for example, by laying a mask over the image such that the features outside of the cell that may be present are not subject to subsequent analysis. If brightfield images are not used, this step can be disregarded. In subsequent steps, only the information that is contained within this mask (i.e. the image of the cell) is used for analysis of the brightfield image. Since the darkfield image is rather blurry, it is typically not segmented but the full image is used for analysis. However, the darkfield image may optionally be segmented.

An advantage of the disclosed work flow is that typically fluorescent compounds, such as stains, and proteins, such as green fluorescent protein (GFP) and the like, are used to label the nuclear content of a cell, which then is used to perform segmentation and derive morphological features, including fluorophore intensities. In the disclosed methods, no staining is required. This leaves the cells free from internal nuclear stain, which typically results in damage to the cells, for example permeabilization, which may render cells unsuitable for additional analysis or cell culture.

In block 310, the features are extracted from each segmented brightfield and the full, or optionally segmented, darkfield image, for example using CellProfiler software (see Table 1 and or Table 3 for an exemplary list of the extracted features). The features can be summarized under the following six categories: Area and shape, Zernike polynomials, granularity, intensity, radial distribution, and texture. Typically all available features are used for classification (for example as listed in Table 1 and or Table 3). In some specific examples, such as for cell cycle classification, features that have the most significant contributions for the classification as ranked by their contribution to the classifier are texture, area and shape, intensity, Zernike polynomials, radial distribution, granularity.

Returning to block 220 in FIG. 2, the extracted features are then used for classification of the cells.

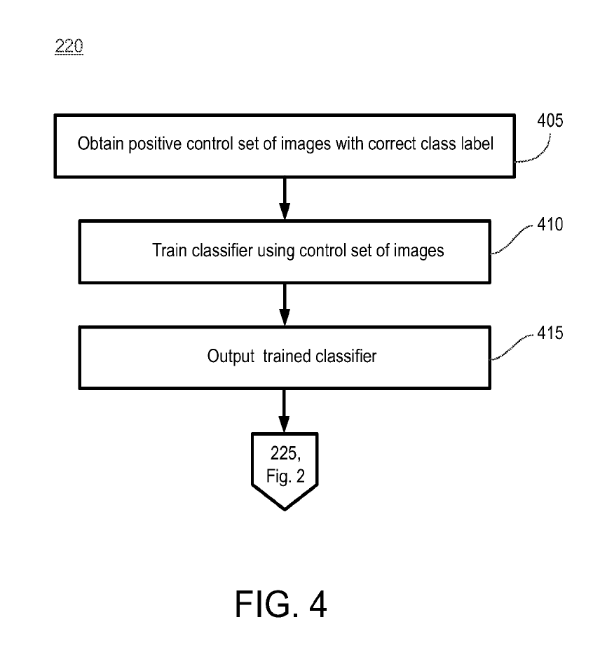

In block 220, the classification of the cell is determined based on the extracted features. In block 220, machine learning classifiers are used to predict the class label of the cell based on its extracted features. Example details of block 220 are described hereinafter with reference to FIG. 4.

With reference to FIGS. 1, 2, 3, and 4 in block 405 of method 220, a defined set of images is obtained that have the correct class labels serving as a positive control set. In some embodiments, the positive control set is defined for each experiment individually (this would be the cases if different types of experiments are run on the machine). In some embodiments, the positive control set is the same across many experiments (if the type of experiment is always the same, e.g. sorting of blood samples into different cell types). In some embodiments, the positive controls are defined using fluorescence signals from fluorescent stains, for example using an imaging flow cytometer that has fluorescent capabilities. In some embodiments, the positive controls are defined by visual inspection of a set of images. Typically this is performed in advance of analysis.

In block 410, the classifier is trained using as inputs, the correct class labels and the extracted features of the images of the positive control set.

In block 415, training of the classifier outputs a trained classifier. The prediction scheme can be used to identify the class of a cell based on its extracted features without knowing its class in advance. The trained classifier can be stored in memory, for example such that it can be shared between users and experiments. Returning to block 225 in FIG. 2, the cell class is output.

In block 225, the cell class labels are assigned to the cells.

In block 230 the assigned cells can be sorted according to the class labels by state-of-the art techniques and/or quantified to output the proportion of cells in each class, such as a graphical representation.

### Other Example Embodiments

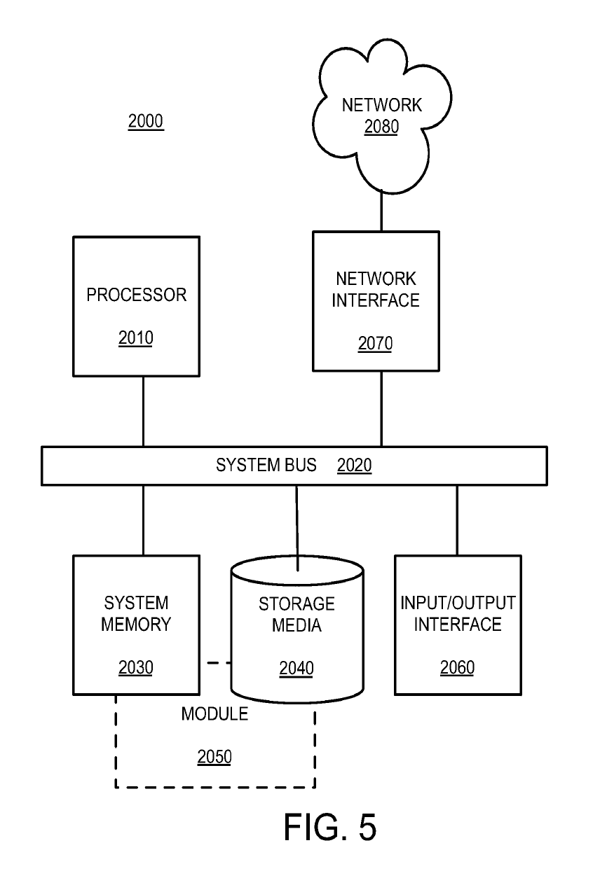

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconflgurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain example embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, any other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (“PCIe”), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the examples described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

TABLE 1
List of extracted features (named as in the CellProfiler software):

Category 1 - area and shape:
AreaShape_Area
AreaShape_Compactness
AreaShape_Eccentricity
AreaShape_Extent
AreaShape_FormFactor
AreaShape_MajorAxisLength
AreaShape_MaxFeretDiameter
AreaShape_MaximumRadius
AreaShape_MeanRadius
AreaShape_MedianRadius
AreaShape_MinFeretDiameter
AreaShape_MinorAxisLength
AreaShape_Perimeter
Category 2 - Zernike polynomials:
AreaShape_Zernike_0_0
AreaShape_Zernike_1_1
AreaShape_Zernike_2_0
AreaShape_Zernike_2_2
AreaShape_Zernike_3_1
AreaShape_Zernike_3_3
AreaShape_Zernike_4_0
AreaShape_Zernike_4_2
AreaShape_Zernike_4_4
AreaShape_Zernike_5_1
AreaShape_Zernike_5_3
AreaShape_Zernike_5_5
AreaShape_Zernike_6_0
AreaShape_Zernike_6_2
AreaShape_Zernike_6_4
AreaShape_Zernike_6_6
AreaShape_Zernike_7_1
AreaShape_Zernike_7_3
AreaShape_Zernike_7_5
AreaShape_Zernike_7_7
AreaShape_Zernike_8_0
AreaShape_Zernike_8_2
AreaShape_Zernike_8_4
AreaShape_Zernike_8_6
AreaShape_Zernike_8_8
AreaShape_Zernike_9_1
AreaShape_Zernike_9_3
AreaShape_Zernike_9_5
AreaShape_Zernike_9_7
AreaShape_Zernike_9_9
Category 3 - granularity:
Granularity_1
Granularity_2
Category 4 - intensity:
Intensity_IntegratedIntensityEdge
Intensity_IntegratedIntensity
Intensity_MADIntensity
Intensity_MassDisplacement
Intensity_MaxIntensityEdge
Intensity_MaxIntensity
Intensity_MeanIntensityEdge
Intensity_MeanIntensity
Intensity_MedianIntensity
Intensity_StdIntensityEdge
Intensity_StdIntensity
Intensity_UpperQuartileIntensity
Category 5 - radial distribution:
RadialDistribution_FracAtD_1
RadialDistribution_FracAtD_2
RadialDistribution_FracAtD_3
RadialDistribution_FracAtD_4
RadialDistribution_MeanFrac_1
RadialDistribution_MeanFrac_2
RadialDistribution_MeanFrac_3
RadialDistribution_MeanFrac_4
RadialDistribution_RadialCV_1
RadialDistribution_RadialCV_2
RadialDistribution_RadialCV_3
RadialDistribution_RadialCV_4
Category 6 - texture:
Texture_AngularSecondMoment_3_0
Texture_AngularSecondMoment_3_135
Texture_AngularSecondMoment_3_45
Texture_AngularSecondMoment_3_90
Texture_Contras_3_0
Texture_Contras_3_135
Texture_Contras_3_45
Texture_Contras_3_90
Texture_DifferenceVariance_3_0
Texture_DifferenceVariance_3_135
Texture_DifferenceVariance_3_45
Texture_DifferenceVariance_3_90
Texture_Gabor
Texture_InverseDifferenceMoment_3_0
Texture_InverseDifferenceMoment_3_135
Texture_InverseDifferenceMoment_3_45
Texture_InverseDifferenceMoment_3_90
Texture_SumAverage_3_0
Texture_SumAverage_3_135
Texture_SumAverage_3_45
Texture_SumAverage_3_90
Texture_SumEntropy_3_0
Texture_SumEntropy_3_135
Texture_SumEntropy_3_45
Texture_SumEntropy_3_90
Texture_SumVariance_3_0
Texture_SumVariance_3_135
Texture_SumVariance_3_45
Texture_SumVariance_3_90
Texture_Variance_3_0
Texture_Variance_3_135
Texture_Variance_3_45
Texture_Variance_3_90

The following examples are provided to illustrate certain particular features and/or embodiments. These examples should not be construed to limit the invention to the particular features or embodiments described.

### EXAMPLES

### Example 1

Imaging flow cytometry combines the high-throughput capabilities of conventional flow cytometry with single-cell imaging (Basiji, D. A. et al. Clinics in Laboratory Medicine 27, 653-670 (2007)). As each cell passes through the cytometer, images are acquired, which can in theory be processed to identify complex cell phenotypes based on morphology. Typically, however, simple fluorescence stains are used as markers to identify cell populations of interest such as cell cycle stage (Filby, A. et al. Cytometry A 79, 496-506 (2011)) based on overall fluorescence rather than morphology.

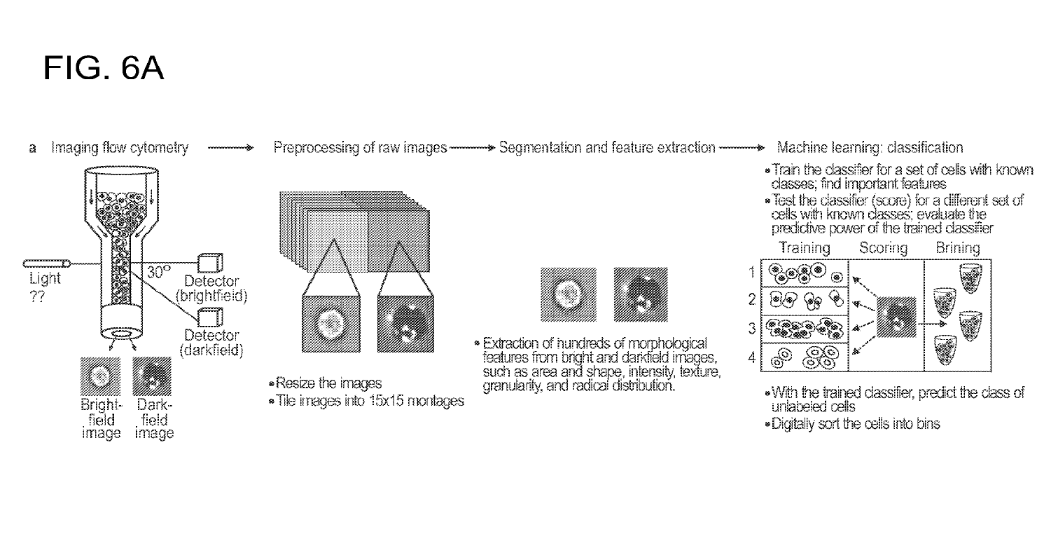

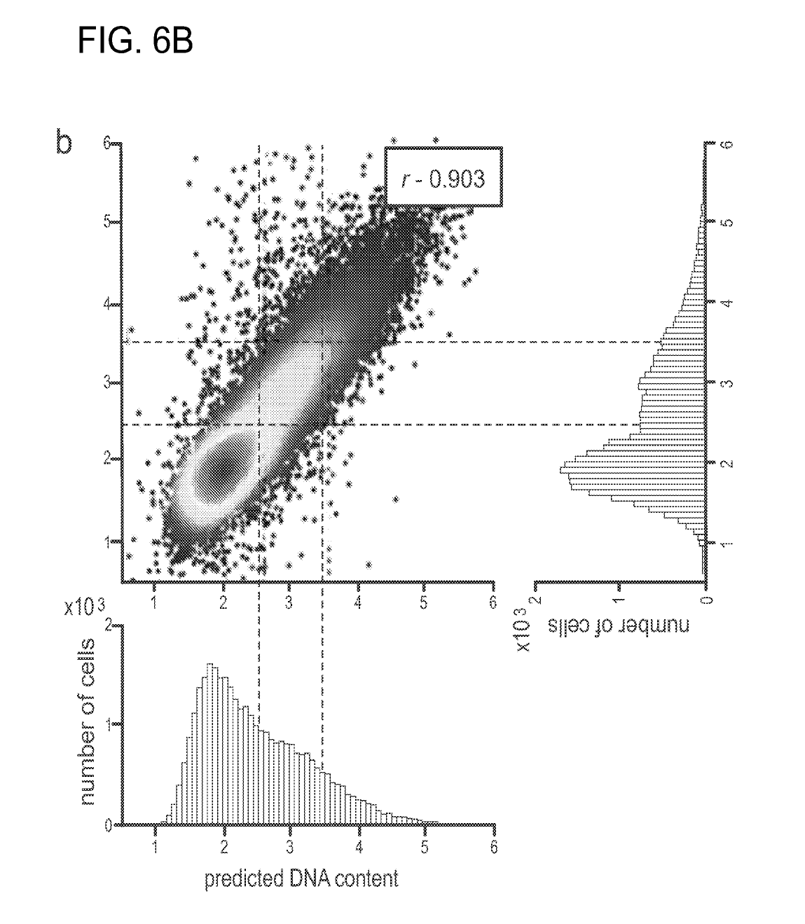

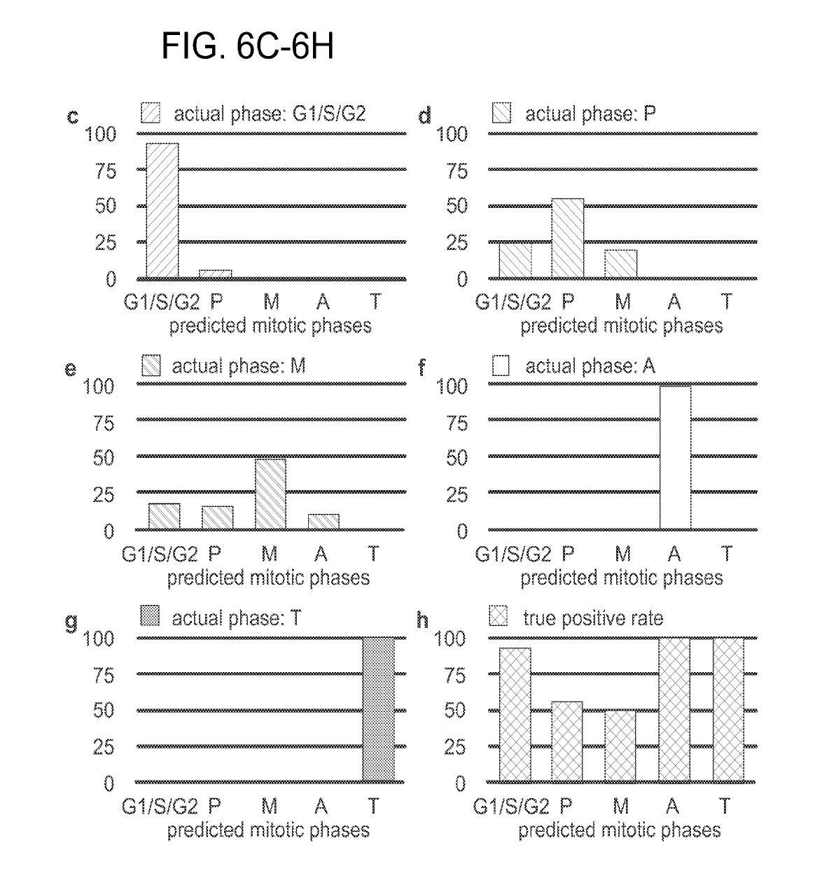

As disclosed herein quantitative image analysis of two largely overlooked channels—brightfield and darkfield, both readily collected by imaging flow cytometers—enables cell cycle-related assays without needing any fluorescence biomarkers (FIG. 6A). Using image analysis software (Eliceiri, K. W. et al. Nature Methods 9, 697-710 (2012), Kamentsky, L. et al. Bioinformatics 27, 1179-1180 (2011)) numerical measurements of cell morphology was extracted from the brightfield and darkfield images, then supervised machine learning algorithms was applied to identify cellular phenotypes of interest, in the present case, cell cycle phases. Avoiding fluorescent stains provides several benefits: it avoids effort and cost, but more importantly avoids the potential confounding effects of dyes, even live-cell compatible dyes such as Hoechst 33342, including cell death (Hans, F. & Dimitrov, S., Oncogene 20, 3021-3027 (2001), Henderson, L. et al. American Journal of Physiology Cell Physiology 304, C927-C938 (2013)). Moreover, it frees up the remaining fluorescence channels of the imaging flow cytometer to investigate other biological questions.

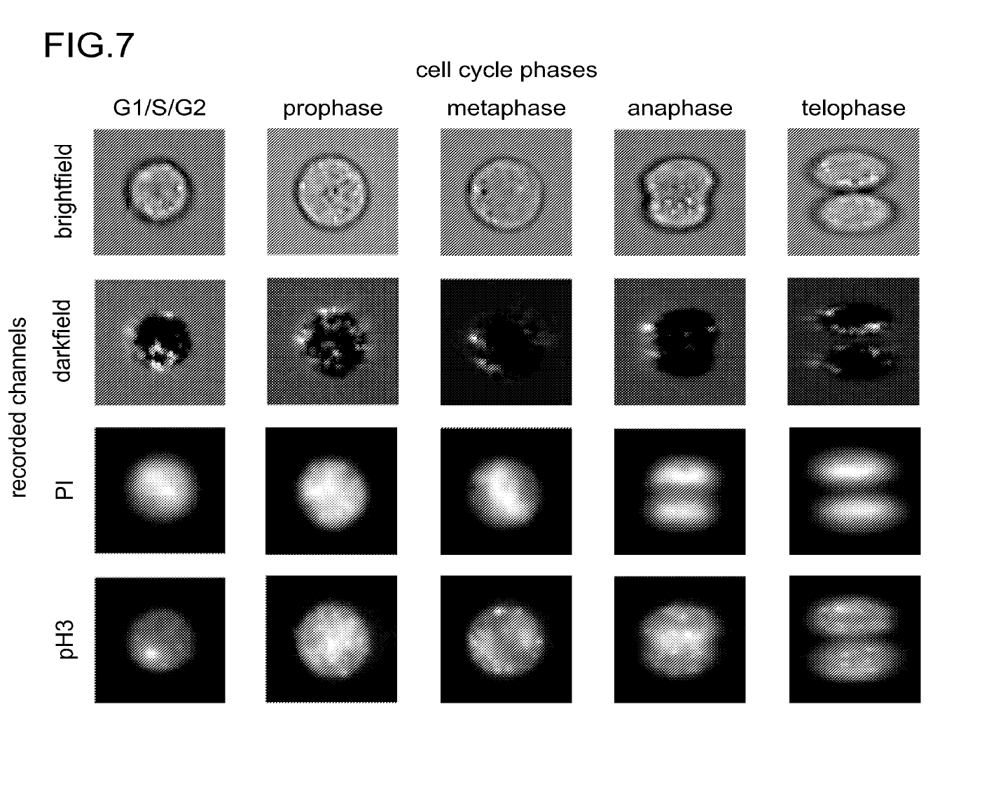

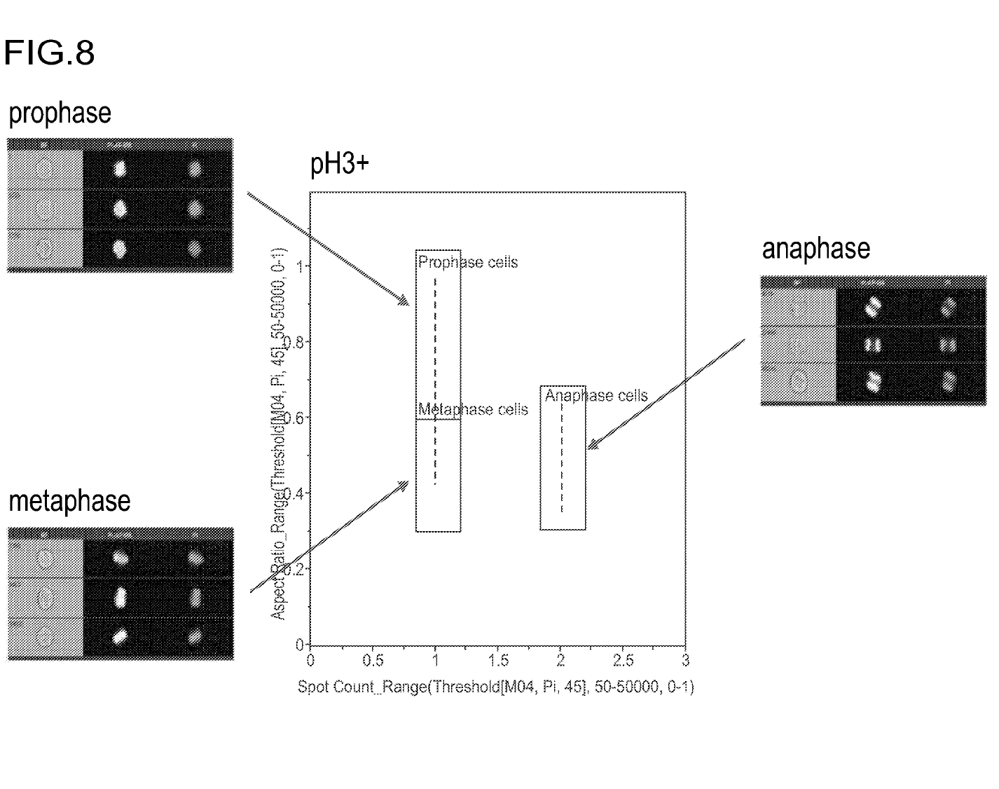

In the tests disclosed herein, a label-free way was developed to measure important cell cycle phenotypes including a continuous property (a cell's DNA content, from which G1, S and G2 phases can be estimated) and discrete phenotypes (whether a cell was in each phase of mitosis: prophase, anaphase, metaphase, and telophase). The ImageStream platform was used to capture images of 32,965 asynchronously growing Jurkat cells (FIG. 7). As controls, the cells were stained with Propidium Iodide to quantify DNA content and an anti-phospho-histone antibody to identify mitotic cells (FIG. 8). These fluorescent markers were used to annotate a subset of the cells with the “ground truth” (expected results) needed to train the machine learning algorithms and to evaluate the predictive accuracy of the disclosed label-free approach (see “METHODS” below).

Using only cell features measured from brightfield and darkfield images, the approach accurately predicted each cell's DNA content, using a regression ensemble (least squares boosting (Hastie, T. et al. The Elements of Statistical Learning, 2^{nd} edn. (Springer, New York, 2008))) (FIG. 6B). This is sufficient to categorize G1, S, and G2 cells, at least, to the extent as is possible based on DNA content (Miltenburger, H. G., Sachse, G. & Schliermann, M, Dev. Biol. Stand 66, 91-99 (1987)). The estimated DNA content can also assign each cell a time position within the cell cycle, by sorting cells according to their DNA content (ergodic rate analysis) (Kafri. R. et. al., Nature 494, 480-43 (2013)). The disclosed method were also able to accurately classify mitotic phases (prophase, anaphase, metaphase, and telophase (FIG. 6C-6H and Table 2).

The disclosed methods provide a label-free assay to determine the DNA content and mitotic phases based entirely on features extracted from a cell's brightfield and darkfield images. The method uses an annotated data set to train the machine learning algorithms, either by staining a subset of the investigated cells with markers, or by visual inspection and assignment of cell classes of interest. Once the machine learning algorithm is trained for a particular cell type and phenotype, the consistency of imaging flow cytometry allows high-throughput scoring of unlabeled cells for discrete and well-defined phenotypes (e.g., mitotic cell cycle phases) and continuous properties (e.g., DNA content).

### Methods

Cell culture and cell staining. Details on the cell culture and the cell staining were published by Filby et al. (see citation above).

Image acquisition by imaging flow cytometry. We used the ImageStream X platform to capture images of asynchronously growing Jurkat cells. For each cell, we captured images of brightfield and darkfield as well as fluorescent channels to measure the Propidium Iodide (PI) that quantifies DNA content and an anti-phospho-histone (pH3) antibody to identify cells in mitosis. After image acquisition, we used the IDEAS analysis tool to discard multiple cells or debris, omitting them from further analysis.

Image processing. The image sizes from the ImageStream cytometer range between ˜30×30 and 60×60 pixels. In this example, the image sizes are reshaped to 55×55 pixel images by either adding pixels with random values that were sampled from the background of the image for images, which are smaller or by discarding pixels on the edge of the image for images, which are too large. The images are then tiled to 15×15 montages, with up to 225 cells per montage. A Matlab script to create the montages can be found online.

Segmentation and feature extraction. The image montages of 15×15 cells were loaded into the open source image software CellProfiler (version 2.1.1). The darkfield image shows light scattered from the cells within a cone centered at a 90° angle and hence does not necessarily depict the cell's physical shape nor does it align with the brightfield image. Therefore the darkfield image is not segmented but instead the full image is used for further analysis. In the brightfield image, there is sufficient contrast between the cells and the flow media to robustly segment the cells. The cells in the brightfield were segmented image by enhancing the edges of the cells and thresholding on the pixel values. The features were then extracted, which were categorized into area and shape, Zernike polynomials, granularity, intensity, radial distribution, and texture. The CellProfiler pipeline can be found online. The measurements were exported in a text file and post-processed using a Matlab script to discard cells with missing values.

Determination of ground truth. To train the machine-learning algorithm a subset of cells was used where the cell's true state is annotated, i.e. the ground truth is known. For this purpose the cells were labeled with a PI and a pH3 stain. As the ground truth for the cells' DNA content the integrated intensities of the nuclear PI stain was extracted with the imaging software CellProfiler. The mitotic cell cycle phases were identified with the IDEAS analysis tool by categorizing the pH3 positive cells into anaphase, prophase and metaphase using a limited set of user-formulated morphometric parameters on their PI stain images followed by manual confirmation. The telophase cells were identified using a complex set of masks (using the IDEAS analysis tool) on the brightfield images to gate doublet cells. Those values were used as the ground truth to train the machine-learning algorithm and to evaluate the prediction of the nuclear stain intensity.

Machine Learning. For the prediction of the DNA content we use LSboosting as implemented in Matlab's fitensemble routine. For the assignment of the mitotic cell cycle phases we use RUSboosting as also implemented in Matlab's fitensemble routine. In both cases we partition the cells into a training and a testing set. The brightfield and darkfield features of the training set as well as the ground truth of these cells are used to train the ensemble. Once the ensemble is trained we evaluate its predictive power on the testing set. To demonstrate the generalizability of this approach and to obtain error bars for the results the procedure is ten-fold cross-validated. To prevent overfitting the data the stopping criterion of the training was determined via five-fold internal cross-validation.

Additionally, the features having the most significant contributions for the prediction of both the nuclear stain and the mitotic phases were analyzed by ‘leave one out’ cross-validation (Table 4). It was found that leaving one feature out has only a minor effect on the results of the supervised machine learning algorithms we used, likely because many features are highly correlated to others. The most important features were intensity, area and shape and radial distribution of the brightfield images.

Table 2 is a Confusion matrix of classification. The genuine cell cycle phases were split into a non-milotic phase (G1/S/G2) and the four mitotic phases prophase, metaphase, anaphase and telophase. We assigned cell cycle phases to the cells using machine learning. All find high true positive classification rates. Even ihough the mitotic phases arc highly underrepresented in the whole population (˜2.2%) the correct class labels could be assigned accurately. Actual cells cycle phases are ihe first column, while predicted phases are the first row

| | G1/ | Pro- | Meta- | Ana- | Telo- | Fraction of |
|---|---|---|---|---|---|---|
| | S/G2 | phase | phase | phase | phase | population |
| G1/ | 92.57 | 4.75 | 1.64 | 0.41 | 0.63 | 97.84 |
| S/G2 | | | | | | |
| Pro- | 25.47 | 54.68 | 19.35 | 0.16 | 0.33 | 1.84 |
| phase | | | | | | |
| Meta- | 19.05 | 17.14 | 50.95 | 11.43 | 1.43 | 0.21 |
| phase | | | | | | |
| Ana- | 0 | 0 | 0 | 100 | 0 | 0.04 |
| phase | | | | | | |
| Teleo- | 0 | 0 | 0 | 0 | 100 | 0.07 |
| phase | | | | | | |

Table 3 is List of brightfieJd and darkfield features extracted with the imaging software CellProfiler. There are six different classes of features: Area and shape. Zernike polynomials, granularity, intensity, radial distribution and texture. Features that were taken for either the brightfield or the darkfield are marked with x, whereas features that were not measured are marked with o (e.g., features that require segmentation were not measured for the darkficld images). For details on the calculation of the features refer to the online manual of the CellProfiler software (as available on line at www.cellprofiler.org).

| Feature | Feature | Feature | Bright- | Dark- |
|---|---|---|---|---|
| class | number | name | field | field |
| Area and | 1 | AreaShape_Area | x | ∘ |
| shape | 2 | AreaShape_Compactness | x | ∘ |
| | 3 | AreaShape_Eccentricity | x | ∘ |
| | 4 | AreaShape_Extent | x | ∘ |
| | 5 | AreaShape_FormFactor | x | ∘ |
| | 6 | AreaShape_MajorAxisLength | x | ∘ |
| | 7 | AreaShape_MaxFeretDiameter | x | ∘ |
| | 8 | AreaShape_MaximumRadius | x | ∘ |
| | 9 | AreaShape_MeanRadius | x | ∘ |
| | 10 | AreaShape_MedianRadius | x | ∘ |
| | 11 | AreaShape_MinFeretDiameter | x | ∘ |
| | 12 | AreaShape_MinorAxisLength | x | ∘ |
| | 13 | AreaShape_Perimeter | x | ∘ |
| Zernike | 14 | AreaShape_Zernike_0_0 | x | ∘ |
| poly- | . . . | . . . | x | ∘ |
| nomials | 43 | AreaShape_Zernike_9_9 | x | ∘ |
| Granu- | 44 | Granularity_1 | x | x |
| larity | . . . | . . . | x | x |
| | 48 | Granularity_5 | x | x |
| Intensity | 49 | Intensity_IntegratedInten- | x | x |
| | | sityEdge | | |
| | 50 | Intensity_IntegratedInten- | x | x |
| | | sity | | |
| | 51 | Intensity_LowerQuartile- | x | x |
| | | Intensity | | |
| | 52 | Intensity_MADIntensity | x | x |
| | 53 | Intensity_MassDisplacement | x | x |
| | 54 | Intensity_MaxIntensityEdge | x | x |
| | 55 | Intensity_MaxIntensity | x | x |
| | 56 | Intensity_MeanIntensityEdge | x | x |
| | 57 | Intensity_MeanIntensity | x | x |
| | 58 | Intensity_MedianIntensity | x | x |
| | 59 | Intensity_MinIntensityEdge | x | x |
| | 60 | Intensity_MinIntensity | x | x |
| | 61 | Intensity_StdIntensityEdge | x | x |
| | 62 | Intensity_StdIntensity | x | x |
| | 63 | Intensity_UpperQuartileInten- | x | x |
| | | sity | | |
| Radial | 64 | RadialDistribution_FracAtD_1 | x | x |
| distri- | 65 | RadialDistribution_FracAtD_2 | x | x |
| bution | 66 | RadialDistribution_FracAtD_3 | x | x |
| | 67 | RadialDistribution_FracAtD_4 | x | x |
| | 68 | RadialDistribution_MeanFrac_1 | x | x |
| | 69 | RadialDistribution_MeanFrac_2 | x | x |
| | 70 | RadialDistribution_MeanFrac_3 | x | x |
| | 71 | RadialDistribution_MeanFrac_4 | x | x |
| | 72 | RadialDistribution_RadialCV_1 | x | x |
| | 73 | RadialDistribution_RadialCV_2 | x | x |
| | 74 | RadialDistribution_RadialCV_3 | x | x |
| | 75 | RadialDistribution_RadialCV_4 | x | x |
| | 76 | Texture_AngularSecond- | x | x |
| | | Moment_3_0 | | |
| Texture | 77 | Texture_AngularSecond- | x | x |
| | | Moment_3_135 | | |
| | 78 | Texture_AngularSecond- | x | x |
| | | Moment_3_45 | | |
| | 79 | Texture_AngularSecond- | x | x |
| | | Moment_3_90 | | |
| | 80 | Texture_Contras_3_0 | x | x |
| | 81 | Texture_Contras_3_135 | x | x |
| | 82 | Texture_Contras_3_45 | x | x |
| | 83 | Texture_Contras_3_90 | x | x |
| | 84 | Texture_Correlation_3_0 | x | x |
| | 85 | Texture_Correlation_3_135 | x | x |
| | 86 | Texture_Correlation_3_45 | x | x |
| | 87 | Texture_Correlation_3_90 | x | x |
| | 88 | Texture_Difference- | x | x |
| | | Entropy_3_0 | | |
| | 89 | Texture_Difference- | x | x |
| | | Entropy_3_135 | | |
| | 90 | Texture_Difference- | x | x |
| | | Entropy_3_45 | | |
| | 91 | Texture_Difference- | x | x |
| | | Entropy_3_90 | | |
| | 92 | Texture_Difference- | x | x |
| | | Variance_3_0 | | |
| | 93 | Texture_Difference- | x | x |
| | | Variance_3_135 | | |
| | 94 | Texture_Difference- | x | x |
| | | Variance_3_45 | | |
| | 95 | Texture_Difference- | x | x |
| | | Variance_3_90 | | |
| | 96 | Texture_Entropy_3_0 | x | x |
| | 97 | Texture_Entropy_3_135 | x | x |
| | 98 | Texture_Entropy_3_45 | x | x |
| | 99 | Texture_Entropy_3_90 | x | x |
| | 100 | Texture_Gabor | x | x |
| | 101 | Texture_InfoMeas1_3_0 | x | x |
| | 102 | Texture_InfoMeas1_3_135 | x | x |
| | 103 | Texture_InfoMeas1_3_45 | x | x |
| | 104 | Texture_InfoMeas1_3_90 | x | x |
| | 105 | Texture_InfoMeas2_3_0 | x | x |
| | 106 | Texture_InfoMeas2_3_135 | x | x |
| | 107 | Texture_InfoMeas2_3_45 | x | x |
| | 108 | Texture_InfoMeas2_3_90 | x | x |
| | 109 | Texture_InverseDifference- | x | x |
| | | Moment_3_0 | | |
| | 110 | Texture_InverseDifference- | x | x |
| | | Moment_3_135 | | |
| | 111 | Texture_InverseDifference- | x | x |
| | | Moment_3_45 | | |
| | 112 | Texture_InverseDifference- | x | x |
| | | Moment_3_90 | | |
| | 113 | Texture_SumAverage_3_0 | x | x |
| | 114 | Texture_SumAverage_3_135 | x | x |
| | 115 | Texture_SumAverage_3_45 | x | x |
| | 116 | Texture_SumAverage_3_90 | x | x |
| | 117 | Texture_SumEntropy_3_0 | x | x |
| | 118 | Texture_SumEntropy_3_135 | x | x |
| | 119 | Texture_SumEntropy_3_45 | x | x |
| | 120 | Texture_SumEntropy_3_90 | x | x |
| | 121 | Texture_SumVariance_3_0 | x | x |
| | 122 | Texture_SumVariance_3_135 | x | x |
| | 123 | Texture_SumVariance_3_45 | x | x |
| | 124 | Texture_SumVariance_3_90 | x | x |
| | 125 | Texture_Variance_3_0 | x | x |
| | 126 | Texture_Variance_3_135 | x | x |
| | 127 | Texture_Variance_3_45 | x | x |
| | 128 | Texture_Variance_3_90 | x | x |

Table 4 is a list of feature importance prediction of DNA content and mitotic phases. To investigate the importance of individual features, we successively excluded one of the feature classes from our analysis. Because many features are correlated, we find no drastic effects when leaving one class of features out. The three feature classes that affect the result of our machine learning algorithms the most are the brightfield feature classes area and shape, intensity, and radial distribution. Moreover, by leaving all brightfield features and all darkfield features out, we find that the brightfield features are more informative then the darkfield features.

| | | Correlation in | Average true positive |
|---|---|---|---|
| | | prediction of | rate for prediction |
| | Left out features | DNA content | of mitotic phases |
| Bright- | Area and shape | 0.902 | 81.8% |
| field | Zernike polynomials | 0.904 | 82.9% |
| | Granularity | 0.903 | 84.3% |
| | Intensity | 0.895 | 79.8% |
| | Radial distribution | 0.894 | 83.1% |
| | Texture | 0.901 | 85.2% |
| Dark- | Granularity | 0.903 | 84.2% |
| field | Intensity | 0.902 | 84.2% |
| | Radial distribution | 0.902 | 84.8% |
| | Texture | 0.903 | 84.6% |
| | (none) | 0.903 | 84.6% |
| | All brightfield features | 0.770 | 68.2% |
| | All darkfield features | 0.896 | 83.8% |

In some examples a boosting algorithm is used for both the classification and the regression (for example as implemented Matlab). In Boosting many, weak classifiers' are combined, each of which contains a decision rule based on ˜5 features. In the end the prediction of all weak classifiers is considered based on a, majority vote′ (e.g. 60/100 for example in an image is class 1 and 40/100 for example it's class 2->boosting predicts class 2). Thus, there is insight into the features of each weak learner—since a single weak learner is a rather bad classifier on its own, this information however is not quite useful.

In Table 5 the question of which features are important is addressed as follows: one set of features (e.g. area & shape, Zernike polynomials, . . . ) is left out and the influence of leaving one set of features out is used to check the accuracy of the classifier/regression. Leaving one set of features out did not have a major effect. This is due to the fact that different sets of features are highly correlated (e.g. for Intensity and area it is already quite intuitive that this should be the case).

| | | Correlation in | Average true positive |
|---|---|---|---|
| | | prediction of | rate for prediction |
| | Left out features | DNA content | of mitotic phases |
| Bright- | Area and shape | 0.895 | 90.2% |
| field | Zernike polynomials | 0.898 | 92.1% |
| | Granularity | | 92.3% |
| | Intensity | 0.888 | 90.8% |
| | Radial distribution | 0.886 | 91.5% |
| | Texture | 0.894 | 92.6% |
| Dark- | Granularity | 0.896 | 92.2% |
| field | Intensity | 0.896 | 92.0% |
| | Radial distribution | 0.896 | 92.9% |
| | Texture | 0.896 | 92.7% |
| | (none) | 0.896 | 92.3% |
| | All brightfield features | 0.758 | 81.8% |
| | All darkfield features | 0.889 | 91.3% |

Protocol for the Analysis Pipeline

Step 1: Extract Single Cell Images and Identify Cell Populations of Interest with Ideas Software
a. Open the IDEAS analysis tool (for example version 6.0.129), which is provided with the ImageStreamX instrument.
b. Load the sif file that contains the data from the imaging flow cytometer experiment into IDEAS using File>Open. Note that any compensation between the fluorescence channels can be carried out at this point. The IDEAS analysis tool will generate a .cif data file and a .daf data analysis file.
c. Perform your analysis within the IDEAS analysis tool following the instructions of the software and identify cells that have each phenotype of interest, using a stain that marks each population. This is known as preparing the “ground truth” (expected result) annotations for the phenotype(s) of interest. In cases when a stain has been used to mark the phenotype(s) of interest in one of the samples, any parameters measured by IDEAS can be used to assign cells to particular classes. In the example data set, the PI (Ch4) images of pH3 (Ch5) positive cells (FIG. 8) are used to identify cells in various mitotic phases.
d. Export the experiment's raw images from IDEAS in .tif format, using Tools>Export .tif images. In the opened window, select the population of which you want to export the images and select the channels you want to export. Change the settings Bit Depth to ‘16-bit (for analysis)’ and Pixel Data to ‘raw (for analysis)’ and click OK. This will export images of the selected population into the folder where you placed your .daf and .cif files. In the example, the cell's brightfield (Ch3), darkfield (Ch6) and PI (Ch4) images were exported (the PI images are only needed to extract the ground truth of the cell's DNA content).
e. Move the exported .tif images into a new folder and rename it with the name of the exported cell population.
f. Repeat step d. and e. for all cell populations you are interested in (in the example Anaphase, G1, G2, Metaphase, Prophase, S and Telophase were exported).

Step 2: Preprocess the Single Cell Images and Combine them to Montages of Images Using Matlab

To allow visual inspection and to reduce the number of .tif files, we tiled the images for the brightfield, darkfield and PI images to montages of 15×15 images. Both steps are implemented in Matlab. The provided Matlab function runs for the exported .tif images of the example data set. To adjust the function for another data set, perform the following steps:
a. Open Matlab (we used version 8.0.0.783 (R2012b))
b. Open the provided Matlab function.
c. Adjust the name of the input directory where the folders containing the single .tif images are located that were extracted from IDEAS in step 1 (in the example ‘./Step2 input single tifs/’).
d. Adjust the name of the output directory where the montages should be stored (in the example ‘./Step2 output tiled tifs/’).
e. Adjust the name of the folders where the single .tif images are located (in the example these are ‘Anaphase’, ‘G1’, ‘G2’, ‘Metaphase’, ‘Prophase’, ‘S’ and ‘Telophase’)
f. Adjust the name of the image channels as they were exported from IDEAS in step 1 (in the example we used ‘Ch3’ (brightfield), ‘Ch6’ (darkfield) and ‘ Ch4’, PI stain).
g. Insert the size of images (we have used 55×55 pixels for each image—this will depend on the size of the cells imaged and also the magnification).
h. Save the Matlab script.
i. Run the Matlab script. The montages of 15×15 images that we created from the example data set.

Step 3: Segment Images and Extract Features Using CellProfiler to Extract Morphological Features from the Brightfield and Darkfield Images and to Determine the Ground Truth DNA Content we Used the Imaging Software CellProfiler.
a. Open CellProfiler (for exmpe version 2.1.1).
b. Load the provided CellProfiler project using File>Open Project.
c. Specify the images to be analyzed by dragging and dropping the folder where the image montages that were created in step 2 are located into the white area inside the CellProfiler window that is specified by ‘File list’.
d. Click on ‘NamesAndTypes’ under the ‘Input modules’ and adjust the names of the image channels as they were exported from IDEAS and specified in step 2 f. Then click on Update
e. Analyze the images by adding analysis modules (as available on the world wide web at www.cellprofiler.org for tutorials on how to use CellProfiler). In the provided CellProfiler pipeline, a grid was defined that is centered at each of the 15×15 single cell images. Features for the darkfield images (granularity, radial distribution, texture, intensity) were extracted but not segment since the darkfield image is recorded under a 90° angle and does not necessarily depict the physical shape of the cell. Next, the brightfield images were segemented without using any stains, but by smoothing the images (CellProfiler module ‘Smooth’ with a Gaussian Filter) followed by an edge detection (CellProfiler module ‘EnhanceEdges’ with Sobel edge-finding) and by applying a threshold (CellProfiler module ‘ApplyThreshold’ with the MCT thresholding method and binary output). The obtained objects were closed (CellProfiler module ‘Morph’ with the ‘close’ operation) and use them to identify the cells on the grid sites (CellProfiler module ‘IdentifyPrimaryObjects’). To filter out secondary objects (such as debris), which are typically smaller than the cells, on the single cell images we measure the sizes of secondary objects (if there are any) and neglect the smaller objects. Then features were extracted for the segmented brightfield images (granularity, radial distribution, texture, intensity, area and shape and Zernike polynomials). In a last step, the intensity of the PI images were extracted that were use as ground truth for the DNA content of the cells.
f. Specify the output folder by clicking on ‘View output settings’ and selecting an appropriate ‘Default Output Folder’.
g. Extract the features of the images by clicking on ‘Analyze Images’.

Step 4: Machine Learning for Label-Free Prediction of the DNA Content and the Cell Cycle Phase of the Cells

### I. Data Preparation

a) Open Matlab (for example version 8.0.0.783 (R2012b)).
b) Open the provided Matlab function).
c) Adjust the name of the input directory where the folders containing the features in .txt format are located that were extracted from CellProfiler in step 3 (in the example ‘./Step3 output features txt/’).
d) Adjust the name of the output directory where the montages should be stored (in the example we used the current working directory).
e) Adjust the name of the feature .txt files of the different image channels as they were exported from CellProfiler (in the example these are ‘BF_cells_on_grid.txt’ for the brightfield features, ‘SSC.txt’ for the darkfield features, ‘Nuclei.txt’ for the DNA stain that we used as ground truth for the machine learning)
f) Change the name of the cell population/classes you extracted, provide class labels for them and specify the number of montages created in step 2 for each of the cell populations/classes.
g) Specify the number of grid places that are on one montage as specified in step 2 (in our example we used 15×15=225).
h) Specify which features exported from CellProfiler in step 3 should be excluded from the subsequent analysis. Features that should be excluded are those that relate to the cells' positions on the grid. For the darkfield images we also excluded features that are related to the area of the image, since we did not segment the darkfield images.
i) Save the Matlab function
j) Run the Matlab function. The Matlab function excludes data rows with missing values corresponding, e.g., to cells where the segmentation failed or to grid sites that were empty. It combines the brightfield and darkfield features to a single data matrix and standardizes it (Matlab function ‘zscore’) to render all features to the same scale. Finally the feature data of the brightfield and darkfield images as well as the ground truth for the DNA content and the cell cycle phases are saved in .mat format.

### II. LSboosting for Prediction of the DNA Content

The DNA content of a cell based is predicted based on brightfield and darkfield features only. This corresponds to a regression for which least squares boosting was used as implemented in the Matlab function ‘fitensemble’ under the option ‘LSBoost’.
a) Open Matlab (for example version 8.0.0.783 (R2012b)).
b) Open the provided Matlab function.
c) Adjust the name of the input data containing the features that was created in step 4 I. to be used for regression).
d) Adjust the name of the ground truth data for the DNA content that was created in step 4.I. to be used to train the regression.
e) Save the Matlab function.
f) Run the Matlab function. In our example we used the settings ‘learnRate’ equal to 0.1 and used standard decision trees ‘Tree’ as the weak learning structure. To fix the stopping criterion (corresponding to the amount of weak learners that is used to fit the data) internal cross-validation was performed (see below). The data is split into a training set (consisting of 90% of the cells) and a testing set (10% of the cells). Then the algorithm is trained on the training set for which the ground truth DNA content of the cells is provided, before it is used to predict the DNA content of the cells in the test set without providing their ground truth DNA content.

### III. RUSboosting for Prediction of the Mitotic Cell Cycle Phases

The mitotic cell cycle phase of a cell is predicted based on brightfield and darkfield features only. This corresponds to a classification problem for which the boosting with random under sampling implemented in the Matlab function ‘fitensemble’ was used under the option ‘RUSBoost’.
a) Open Matlab (for example version 8.0.0.783 (R2012b)).
b) Open the provided Matlab function.
c) Adjust the name of the input data containing the features that was created in step 4 I. to be used for regression.
d) Adjust the name of the ground truth data for the phases that was created in step 4.I. to be used to train the regression.
e) Save the Matlab function.
f) Run the Matlab function. In our example we used the settings ‘LearnRate’ equal to 0.1 and specified the decision tree structure that we used as the weak learning structure by setting the number of leafs ‘minleaf’ to 5. To fix the stopping criterion (corresponding to the amount of weak learners that is used to fit the data) we performed internal cross-validation (see below). Again, the data is split into a training set (90% of the cells) and a testing set (10% of the cells). Then the algorithm is trained on the training set for which the ground truth cell cycle phases of the cells is provided, before it is used to predict the cell cycle phase of the cells in the test set without providing their ground truth cell cycle phases. To show that the label-free prediction of cell cycle phases is robust we performed a ten-fold cross-validation.

### Internal Cross Validation to Determine the Stopping Criterion

To prevent overfitting the data and to fix the stopping criterion for the applied boosting algorithms, a five-fold internal cross-validation was performed. To this end, we split up the training set into an internal-training (consisting of 80% of the cells in the training set) and an internal-validation (20% of the cells in the training set) set. The algorithm was trained on the internal-training set with up to 6,000 decision trees. The DNA content/cell cycle phase of the inner-validation set and evaluate the quality of the prediction as a function of the used amount of decision trees was predicted. The optimal amount of decision trees is chosen as the one for which the quality of the prediction is best. This procedure is repeated five times and determine the stopping criterion for the whole training set as the average of the five values for the stopping criterion obtained in the internal cross-validation.

### Example 2

The disclosed method was applied for the classification of cell cycle phases of both Jurkat and yeast cells. As a positive control a data set was obtained with the cells labeled with fluorescent markers of the cell cycle. For the classification we used RUSboost (Seiffer et al., “RUSBoost: A Hybrid Approach to Alleviating Class Imbalance, IEEE Transaction on Systems, Man and Cybernetics-Part A: Systems and Human, Vol. 40(1), January 2010) as implemented in Matlab.

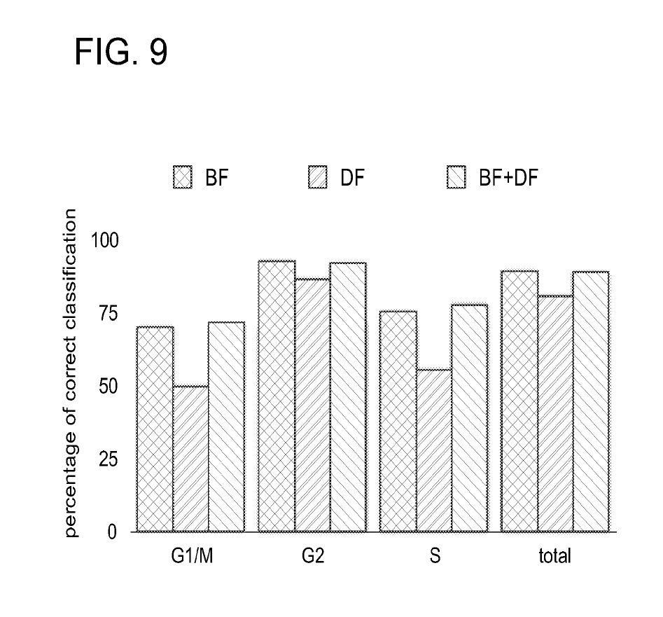

For the yeast cells the brightfield and the darkfield images were used for classification. The percentage of correct classification based on features extracted from those images is 89.1% (see FIG. 9 for details).

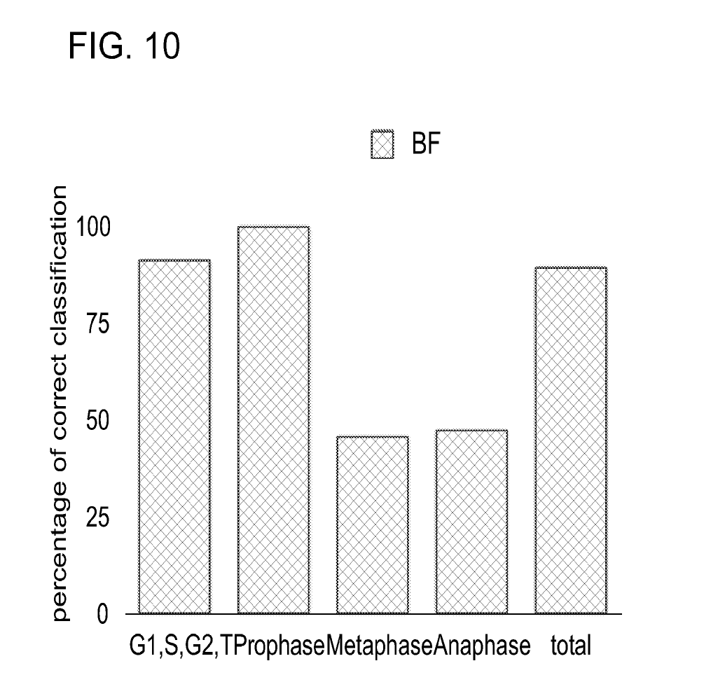

For the Jurkat cells only the brightfield images were used. The percentage of correct classification based on the brightfield images is 89.3% (see FIG. 10 for details).

In view of the many possible embodiments to which the principles of our invention may be applied, it should be recognized that illustrated embodiments are only examples of the invention and should not be considered a limitation on the scope of the invention. Rather, the scope of the invention is defined by the following claims. We therefore claim as our invention all that comes within the scope and spirit of this disclosure and these claims.

1-26. (canceled)

27. A computer-implemented method for the label-free classification of cells using image cytometry, comprising;
receiving, by one or more computing devices, one or more label free images of a cell; and
identifying, by the one or more computing devices, a cell class for each imaged cell by applying a machine learning classifier to the one or more label free images of each cell.

28. The method of claim 27, wherein the machine learning classifier comprises deep learning.

29. The method of claim 28, wherein identifying a cell class for each imaged cell comprises obtaining, by the one or more computing devices, a set of vectors for each of the one or more label free images, each vector comprising pixel data from the label free images, wherein deep learning is applied to the set of vectors.

30. The method of claim 27, wherein identifying a cell class for each imaged cell comprises extracting, by the one or more computing devices, features of the one or more images, wherein the machine learning classifier determines a cell class for each imaged cell based, at least in part, on the extracted features.

31. The method of claim 30, wherein the features comprise two or more of the features listed in Table 1 or 2.

32. The method of claim 30, wherein the features are ranked based on one or more of texture, area and shape, intensity, Zernike polynomials, radial distribution, and granularity.

33. The method of claim 30, further comprising segmenting, using the one or more computing devices, the label free image to identify the cell in the image and wherein the segmented image is used for feature extraction.

34. The method of claim 27, wherein the machine learning classifier is obtained by training the machine learning classifier using a training set of cell images of known cell class.

35. The method of claim 27, further comprising acquiring, by the one or more computing devices, the one or more images, wherein at least one of the one or more computing devices is in electronic communication with an imagine device.

36. The method of claim 35, further comprising sorting, by a cell sorting device, each cell based on the identified cell class received from the one or more computing devices.

37. The method of claim 27, wherein the label free image is a brightfield image, a darkfield image, or both.

38. A system to for the label-free classification of cells using image cytometry, the system comprising:
a cell imaging device and a storage device communicatively coupled to a processor, wherein the processor executes application code instructions that are stored in the storage device and that cause the system to:
obtain one or more label free images of a cell or set of cells; and
identify a cell class for each imaged cell by applying a machine learning classifier to the one or more label free images.

39. The system of claim 38, wherein the machine learning classifier comprises deep learning.

40. The system of claim 39, wherein identifying a cell class for each imaged cell comprises determining a set of vectors for each of the one or more label free images, each vector comprising pixel data from the label free images, wherein deep learning is applied to the set of vectors.

41. The system of claim 38, wherein identifying cell class for each imaged cell comprises extracting features of the one or more label fee cell images, wherein the machine learning classifier determines a cell class for each imaged cell based, at least in part, on the extracted features.

42. The system of claim 41, wherein the features comprise two or more of the features listed in Table 1 or 2.

43. The system of claim 41, wherein the features are ranked based one or more of texture, area and shape, intensity, Zernike polynomials, radial distribution, and granularity.

44. The system of claim 41, further comprising application coded instructions that cause the system to segment the label free image to identify the cell in the image and wherein the segmented label free image is used for feature extraction.

45. The system of claim 38, further comprising a cell sorting device, wherein the cell sorting device is communicatively coupled to the processor and wherein the cell sorting device sorts the imaged cells based on the identified cell class.

46. The system of claim 38, wherein the label free image is a brightfield image, a darkfield image, or both.

47. A computer program product, comprising:
a non-transitory computer-executable storage device having computer-readable program instructions embodied thereon that when executed by a computer cause the computer to make a label free classification of cells, the computer-executable program instructions comprising:
computer-executable program instructions to receive one or more label free images of a cell; and
computer-executable program instructions to identify a cell class for each imaged cell by applying a machine learning classifier to the one or more label free images of each cell.

48. The computer program product of claim 47, wherein the machine learning classifier comprises deep learning.

49. The computer program product of claim 48, wherein the computer-executable program instructions to identify a cell class for each imaged cell comprise computer-executable instructions to obtain a set of vectors for each of the one or more label free images, each vector comprising pixel data from the label free images, wherein the computer-executable instructions apply deep learning to the set of vectors.

50. The computer program product of claim 49, wherein the computer-executable program instruction to identify a cell class for each imaged cell comprise computer-executable instructions to extract features of the one or more images, wherein the machine learning classifier determines a cell class for each imaged cell based, at least in part, on the extracted features.

51. The computer program product of claim 50, wherein the features comprise two or more of the features listed in Table 1 or Table 2.

52. The computer program product of claim 50, wherein the features are ranked based on one or more of texture, area and shape, intensity, Zernike polynomials, radial distribution, and granularity.

53. The computer program product of claim 47, further comprising computer-executable program instructions to segment the label free image to identify the cell in the image and wherein the segmented image is used for feature extraction.

54. The computer program product of claim 47, further comprising computer-executable program instructions to communicate a sort command to a cell sorting device, the sort command comprising computer-executable instruction to sort each cell based on the identified cell class.
